(19) United States
(12) Patent Application Publication
(10) Pub. No.: US 2022/0218169 A1
(43) Pub. Date: Jul. 14, 2022

(54) CLEANER SYSTEM, CLEANER, AND DIRT DETERMINATION PROGRAM

(71) Applicant: Panasonic Intellectual Property Management Co., Ltd., Osaka (JP)

(72) Inventors: Kan MINAHASHI, Shiga (JP); Yuko TSUSAKA, Kyoto (JP); Renji HONDA, Nara (JP)

(21) Appl. No.: 17/405,997

(22) Filed: Aug. 18, 2021

(30) Foreign Application Priority Data
Jan. 8, 2021 (JP) 2021-002186

(51) Int. Cl. A47L 9/28; G06K 9/00; G06K 9/62; G05D 1/02; A47L 9/00

(52) U.S. Cl. CPC A47L 9/2815; A47L 2201/06; G06K 9/6256; G06K 9/00805; G06K 9/6267; G05D 1/0214; A47L 9/2826; A47L 9/2852; A47L 9/2847; A47L 9/2857; A47L 9/009; A47L 9/2842; G05D 2201/0203; A47L 2201/04; G06K 9/00664

(57) ABSTRACT

A cleaner system includes an autonomous travel type cleaner and an information processing apparatus. The information processing apparatus includes a first information generator that generates first information about dirt based on a plurality of pieces of image data indicating a floor surface. The cleaner includes an imaging device that images the floor surface. The cleaner system includes a second information generator that generates second information based on image data acquired from the imaging device, a determination unit that determines whether the second information indicates dirt, based on the first information and generates a determination result, and a cleaning controller that changes a cleaning operation on the floor surface on which the second information is acquired, based on the determination result of the determination unit.

### BACKGROUND

### 1. Technical Field

The present disclosure relates to a cleaner system including a cleaner that can autonomously travel to clean a home and a common area such as a corridor of a public facility or an office building, and an information processing apparatus, to a cleaner used in the cleaner system, and to a dirt determination program.

### 2. Description of the Related Art

An autonomous traveling cleaner known in the art acquires a thermal image or measures a concentration of gas to detect excrement of a living being on a floor surface, and switches an operation mode (see, for example, JP 2018-515191 A (hereinafter, referred to as “Patent Document 1”)).

On the other hand, dirt adhering to a floor surface including a carpet, such as dust accumulating on the floor surface and sand brought to the floor surface from shoes, is difficult to be detected due to a design or the like on the floor surface under certain conditions.

### SUMMARY

The present disclosure provides a cleaner system, a cleaner, and a dirt determination program capable of appropriately determining dirt on a floor surface.

A cleaner system from one aspect of the present disclosure includes an autonomous traveling cleaner that autonomously travels to clean a floor surface, and an information processing apparatus that processes information about dirt on the floor surface. The information processing apparatus includes a first information generator that generates first information about the dirt based on a plurality of pieces of image data indicating the floor surface. The cleaner includes an imaging device that images the floor surface. The cleaner system includes a second information generator that generates second information based on image data acquired from the imaging device, a determination unit that determines whether the second information indicates dirt, based on the first information and generates a determination result, and a cleaning controller that changes a cleaning operation on the floor surface on which the second information is acquired, based on the determination result of the determination unit.

Further, a cleaner from another aspect of the present disclosure includes an imaging device that images a floor surface, an information acquisition unit that acquires first information about dirt based on a plurality of pieces of image data indicating the floor surface and a determination model trained by the first information, a second information generator that generates second information based on image data acquired from the imaging device, a determination unit that determines whether the second information indicates the dirt, based on the first information or using the determination model trained by the first information and generates a determination result, and a cleaning controller that changes a cleaning operation on the floor surface on which the second information is acquired, based on the determination result of the determination unit.

Further, a dirt determination program from another aspect of the present disclosure is used in a cleaner system that includes an autonomous traveling cleaner that autonomously travels to clean a floor surface and an information processing apparatus that processes information about dirt on the floor surface. The dirt determination program is executed by a processor to achieve a first information generator that generates first information about dirt based on a plurality of pieces of image data indicating the floor surface, a second information generator that generates second information based on image data indicating the floor surface, a determination unit that determines whether the second information indicates dirt, based on the first information and generates a determination result, and a cleaning controller that changes a cleaning operation on the floor surface on which the second information is acquired, based on the determination result of the determination unit.

The present disclosure can provide a cleaner system, a cleaner, and a dirt determination program capable of reducing erroneous determination of dirt on a floor surface and appropriately cleaning the floor surface.

### BRIEF DESCRIPTION OF THE DRAWINGS

FIG. 1 is a block diagram illustrating functional units of a cleaner system according to an exemplary embodiment;

FIG. 2 is a side view illustrating an external appearance of a cleaner according to the exemplary embodiment;

FIG. 3 is a bottom view illustrating the external appearance of the cleaner according to the exemplary embodiment;

FIG. 4 is a flowchart of an operation for generating first information according to the exemplary embodiment; and

FIG. 5 is a flowchart of a cleaning operation performed by the cleaner according to the exemplary embodiment.

### DETAILED DESCRIPTION

An exemplary embodiment of a cleaner system, a cleaner, and a dirt determination program according to the present disclosure will be described below with reference to the drawings. Note that the following exemplary embodiment is merely an example for describing the present disclosure, and does not limit the present disclosure. For example, a shape, a structure, a material, a component, a relative positional relationship, a connection state, a numerical value, a mathematical expression, description of each step in a method, an order of each step, and the like described in the following exemplary embodiment are merely examples, and the present disclosure may include matters that are not described below. Further, geometric expressions such as “parallel” and “orthogonal” may be used, but these expressions do not indicate mathematical strictness, and include substantially acceptable errors, deviations, and the like. In addition, expressions such as “simultaneous” and “identical” include substantially acceptable ranges.

Further, the drawings are schematic drawings in which emphasis, omission, or ratio adjustment is appropriately performed in order to describe the present disclosure. Thus, actual shapes, positional relationships, and ratios are different from those of the drawings.

Further, a plurality of inventions may be comprehensively described below as one exemplary embodiment. Further, some parts of the content are described below as any components regarding the present disclosure.

### Exemplary Embodiment

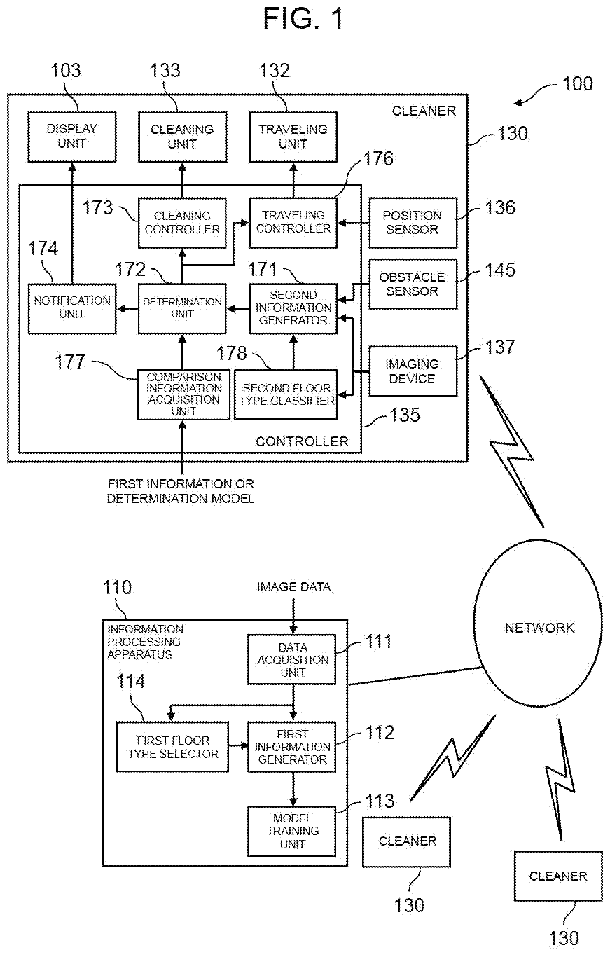

FIG. 1 is a block diagram illustrating functional units of a cleaner system according to an exemplary embodiment. Cleaner system 100 is a system that generates a cleaning plan related to a floor surface of a home, a hotel, a building for rent, a factory, or the like, and causes cleaner 130 to autonomously travel and perform cleaning in accordance with the generated cleaning plan. In the present exemplary embodiment, cleaner system 100 includes information processing apparatus 110 and cleaner 130.

Information processing apparatus 110 is an apparatus that processes information about dirt on a floor surface and provides the processed information to cleaner 130, and can transmit and receive information to and from cleaner 130 via a network. In the present exemplary embodiment, information processing apparatus 110 is a so-called server including a processor, a storage device, various interfaces, and the like. Information processing apparatus 110 includes data acquisition unit 111 and first information generator 112 as processing units achieved by causing the processor to execute a program. In the present exemplary embodiment, information processing apparatus 110 includes model training unit 113 and first floor type classifier 114.

Data acquisition unit 111 is a processing unit that acquires image data indicating a floor surface. Data acquisition unit 111 acquires the image data not from limited devices, and can acquire from a mobile terminal such as a smartphone or a tablet terminal, cleaner 130, a digital camera, or the like via a network or directly.

First information generator 112 generates information indicating a floor surface and a state of dirt on the floor surface based on the image data indicating the floor surface. A specific example of the first information is a feature amount obtained by digitalizing an arrangement (design or pattern) or the like in at least one item in the image data such as hue, saturation, and lightness. First information generator 112 generates the first information as the feature amount from the image data using any method, and may generate the first information using artificial intelligence. First information generator 112 may exclude, from the acquired image data, an obstacle on the floor surface analyzed as being different from the floor surface by an image analysis or the like. This enables generation of highly reliable first information.

First floor type classifier 114 is a processing unit that classifies a type of the floor surface indicated by the image data acquired by data acquisition unit 111. First floor type classifier 114 detects a floor type such as a wood floor, tiles, a thin-piled carpet, a thick-piled carpet, or tatami mats, based on the image data to classify the types, and associates the image data with data indicating the floor types. Note that first floor type classifier 114 may classify the floor types based on a hue, saturation, lightness, a design, and the like of the floor surface. Further, floor types may be classified based on an input from a user.

Model training unit 113 acquires a plurality of different pieces of first information as feature amounts, and trains a determination model using the first information, a human evaluation and another evaluation of a state of dirt on the floor surface indicated by the image data. The determination model is a nonlinear regression model used for deep learning, machine learning, and the like.

In the present exemplary embodiment, first floor type classifier 114 associates the first information generated from the image data with the floor types, and thus model training unit 113 trains a plurality of determination models trained for each classified floor. The trained determination model is provided to cleaner 130 via a network or the like.

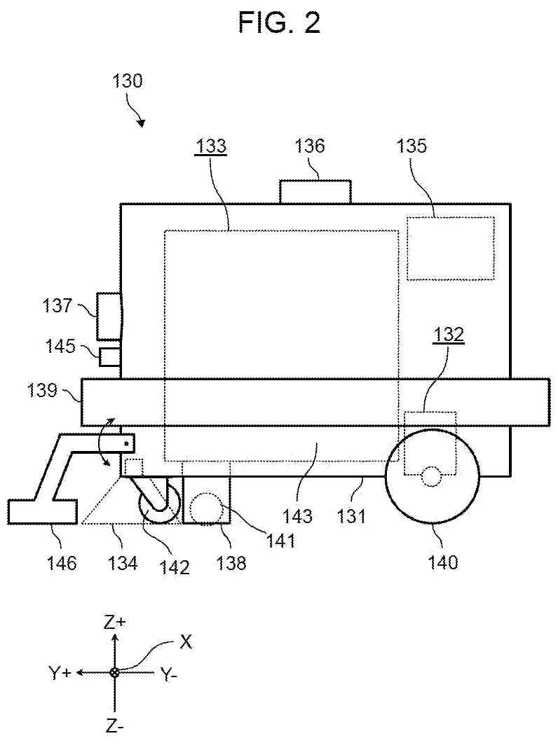

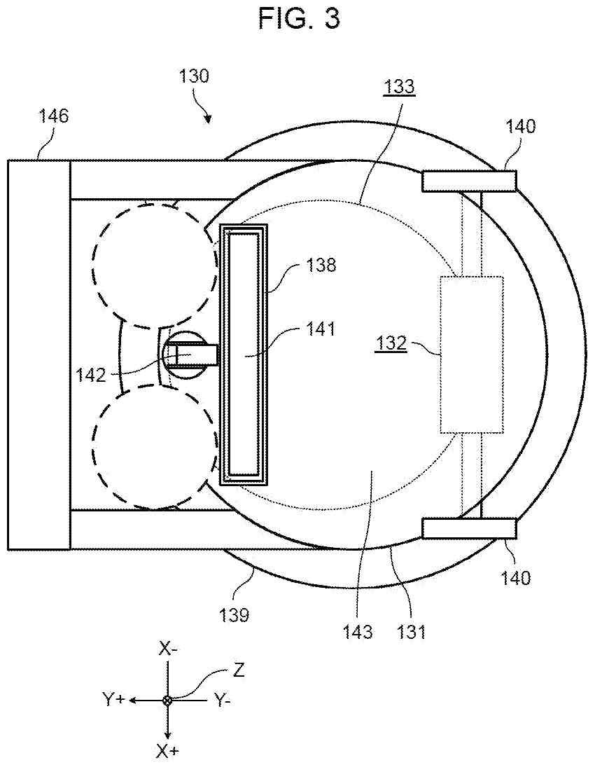

FIG. 2 is a side view illustrating an external appearance of the cleaner according to the exemplary embodiment. FIG. 3 is a bottom view illustrating the external appearance of the cleaner according to the exemplary embodiment. As illustrated in these drawings, cleaner 130 according to the exemplary embodiment is robot cleaner 130 that autonomously travels in a cleaning area defined on a floor surface to suck up dust.

According to the present exemplary embodiment, cleaner 130 includes body 131 on which various components are mounted, traveling unit 132 that moves body 131, cleaning unit 133 that collects dust present on a floor surface, imaging device 137, controller 135, position sensor 136, and obstacle sensor 145.

Body 131 is a housing that houses traveling unit 132, controller 135, and the like. Its upper portion is detachable from its lower portion. Bumper 139 which is displaceable with respect to body 131 is attached to an outer peripheral portion of body 131. Further, as illustrated in FIG. 3, body 131 has suction port 138 for sucking dust into body 131.

Traveling unit 132 is a device that causes cleaner 130 to travel based on an instruction from controller 135. In the present exemplary embodiment, cleaner 130 includes position sensor 136, and traveling unit 132 also functions as a device that moves position sensor 136. Traveling unit 132 includes wheels 140 that move along a floor and a traveling motor (not illustrated) that applies a torque to wheels 140. Caster 142 is mounted as an auxiliary wheel on a bottom surface of body 131. Independently controlling the rotation of two wheels 140 enables cleaner 130 to freely travel forward, travel backward, turn left, turn right, and the like.

Cleaning unit 133 is a unit that sucks dust through suction port 138 into body 131 and holds the dust. Cleaning unit 133 includes an electric fan (not illustrated) and dust holding unit 143. The electric fan sucks air inside dust holding unit 143 and discharges the air to the outside of body 131 to suck dust through suction port 138 and store the dust into dust holding unit 143. Cleaning unit 133 includes main brush 141 that sweeps up dust and the like on the floor surface into suction port 138, and side brush 134 that sweeps and collects dust for sucking the dust through suction port 138.

Cleaning unit 133 includes cleaning member 146. Cleaning member 146 is not particularly limited, but, in the present exemplary embodiment, may have a replaceable sheet that can be pressed against the floor surface to wipe a floor surface. Note that cleaning unit 133 may include a detergent application device that sprays detergent onto a floor surface and an infiltration device that infiltrates detergent into cleaning member 146.

Position sensor 136 detects a positional relationship including a distance between cleaner 130 and an object including a wall or the like existing around cleaner 130 on the floor surface and a direction of the object. Further, position sensor 136 also can get a self-position of cleaner 130 from the information about the direction and distance detected by position sensor 136. The type of position sensor 136 is not particularly limited, and its examples are a light detection and ranging (LiDAR) camera and a time of flight (ToF) camera that emit light and detect a position and a distance based on returned light reflected by an obstacle. A further example of position sensor 136 is a compound eye camera that acquires illumination light or natural light reflected by an obstacle as an image and acquires the position and the distance based on parallax.

Obstacle sensor 145 is a sensor for detecting an obstacle placed on a floor surface. In the present exemplary embodiment, obstacle sensor 145 is a sensor capable of detecting an obstacle that is not so high above a floor surface, such as paper, cloth, or excrement of a living being placed on the floor surface.

Note that cleaner 130 may include a sensor in addition to position sensor 136 and obstacle sensor 145. Cleaner 130 may include, for example, a floor surface sensor that is disposed at a plurality of places on the bottom surface of body 131 and detects whether a descending step such as a staircase is present. Further, cleaner 130 may include an encoder that is provided in traveling unit 132 and detects a rotation angle of each of the pair of wheels 140 rotated by the traveling motor. Further, cleaner 130 may include an acceleration sensor that detects acceleration during traveling of cleaner 130, and an angular velocity sensor that detects an angular velocity during turning of cleaner 130. Cleaner 130 may include a contact sensor that detects displacement of bumper 139 to detect collision with an obstacle.

Imaging device 137 is a device that images a floor surface. The type of imaging device 137 is not particularly limited, and in the present exemplary embodiment, cleaner 130 includes a digital camera having an optical system and an imaging element as imaging device 137.

Cleaner 130 includes second information generator 171, determination unit 172, and cleaning controller 173 as processing units achieved by causing a processor included in controller 135 to execute a program. In the present exemplary embodiment, cleaner 130 further includes notification unit 174, obstacle detector 175, travel controller 176, comparative information acquisition unit 177, and second floor type classifier 178.

Second information generator 171 generates second information based on image data acquired by imaging device 137. In the present exemplary embodiment, second information generator 171 uses a method similar to the method with which first information generator 112 of information processing apparatus 110 generates the first information, and generates a feature amount as the second information from the image data. The second information is information indicating the floor surface indicated in the image acquired by imaging device 137 and the state of dirt on the floor surface. Second information generator 171 may generate the second information from image data excluding the obstacle detected by obstacle detector 175. As a result, the data amount of the image data for generating the second information can be reduced, and the second information can be acquired with high accuracy and at high speed.

Note that second information generator 171 may associate the self-position of cleaner 130 obtained by position sensor 136 with the second information generated based on the image data.

Second floor type classifier 178 is a processing unit that classifies the type of floor surface indicated by the image data imaged by imaging device 137. Second floor type classifier 178 detects a floor type such as a wood floor, tiles, a thin-piled carpet, a thick-piled carpet, or tatami mats similar to those detected and classified by first floor type classifier 114, based on the image data to classify the floor type, and associates the second information with data indicating the floor type.

A classification method used by second floor type classifier 178 is not particularly limited, and for example, the floor type may be classified by analyzing the image data acquired by imaging device 137. Further, the floor type may be classified based on position information acquired by position sensor 136 during the imaging of a floor surface. Further, the floor type may be classified based on an input from a user.

Determination unit 172 determines whether the second information generated by second information generator 171 indicates dirt, based on the first information acquired from information processing apparatus 110, and generates a determination result. In the present exemplary embodiment, comparative information acquisition unit 177 acquires a determination model trained by the first information in information processing apparatus 110, and determination unit 172 uses the acquired determination model to determine whether the second information indicates dirt and generate a determination result.

In the present exemplary embodiment, model training unit 113 of information processing apparatus 110 trains a plurality of determination models corresponding to a plurality floor types, and comparative information acquisition unit 177 acquires the plurality of types of trained models.

Determination unit 172 inputs the second information into the determination model corresponding to the second information classified by second floor type classifier 178, and generates a determination result indicating the type of dirt, the degree of dirt, and the like indicated by the second information. Determination accuracy can be improved by making the determination of the dirt using the determination model corresponding to a floor type.

Note that determination unit 172 may compare the plurality of pieces of first information with the generated second information without using the trained model to determine the degree of the dirt based on the first information similar to the second information, and generate a determination result.

Cleaning controller 173 changes a cleaning operation on the floor surface, on which the second information is acquired, in accordance with the determination result of determination unit 172. In the present exemplary embodiment, cleaning controller 173 causes cleaning unit 133 to perform cleaning corresponding to the self-position, roughly based on a cleaning plan, but executes changes in a suction force, whether the brush is rotated, whether cleaning member 146 is used, and the like in accordance with the determination result of determination unit 172. For example, when determination unit 172 determines that the state of dirt on the floor surface is dust adhered onto a thin-piled carpet and generated in daily life, cleaning controller 173 causes cleaning unit 133 to operate main brush 141 and side brush 134 and sweep and collect the dust to suck the dust through suction port 138. Further, when determination unit 172 determines that the state of dirt on the floor surface is a liquid on a wood floor, cleaning controller 173 stops the suction from main brush 141 and side brush 134 through suction port 138. Cleaning controller 173 then causes cleaning unit 133 and traveling unit 132 to move and push cleaning member 146 against the floor surface and to move cleaning member 146 along the liquid. Note that when determination unit 172 determines that the dirt cannot be handled by cleaner 130, additionally based on the information from obstacle sensor 145, cleaning controller 173 may regard the dirt as an obstacle and cause traveling unit 132 to avoid the obstacle.

Notification unit 174 notifies of the determination result in determination unit 172. Examples of the notification are the state of dirt on a floor surface, the type of dirt, and presence of dirt that cannot be handled by cleaner 130 on a floor surface. A notification method used by notification unit 174 is not particularly limited, and examples thereof include displaying an image including a text on display unit 103, outputting a sound including a melody and a warning sound, and the like.

Operations of cleaner system 100 will be described below.

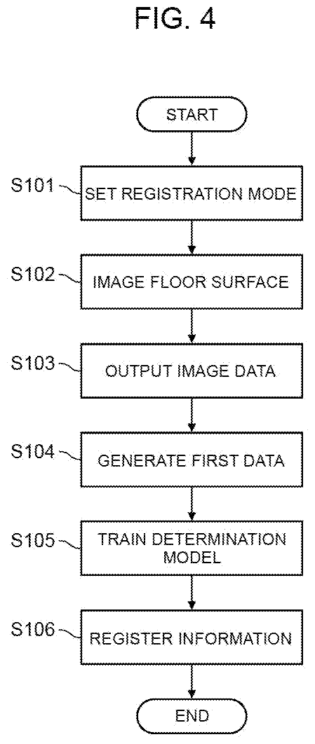

First, a flow of an operation for generating the first information will be described. FIG. 4 is a flowchart of the operation for generating the first information. When cleaner 130 is introduced for the first time, a cleaning place is changed, or the type including a design of a floor is changed, cleaner 130 acquires image data for causing information processing apparatus 110 to generate the first information, from imaging device 137. Specifically, cleaner 130 is set to a registration mode on a relatively clean floor surface (S101).

Cleaner 130 is then caused to travel in accordance with a preset cleaning plan, and the floor surface is imaged at predetermined intervals by imaging device 137 (S102). The imaged image data is associated with the self-position information about cleaner 130 acquired by position sensor 136, the information about the floor type acquired by cleaner 130 thorough the sensor or a user's input, and the like, and the associated information is transmitted to information processing apparatus 110 (S103). Note that cleaner 130 may remove an obstacle from the image data based on the information of obstacle sensor 145 and output the image data.

First information generator 112 of information processing apparatus 110 generates first information that is a feature amount, based on the acquired image data (S104). Model training unit 113 trains a determination model based on the generated first information and information that is image data acquired by imaging a relatively clean floor surface (S105). The trained determination model is registered in the storage device included in information processing apparatus 110 (S106).

Note that the determination model may be registered after being associated with the self-position information indicating the imaging position acquired from the cleaner, the information about the type of the imaged floor, and the like. Further, although the case where the determination model is registered has been exemplified, the first information may be registered in the storage device without using the determination model. The self-position information, the floor information, and the like may be associated with the first information. In addition, information processing apparatus 110 may acquire image data from a plurality of cleaners 130, a mobile terminal such as a smartphone, or the like to generate first information, and train the determination model.

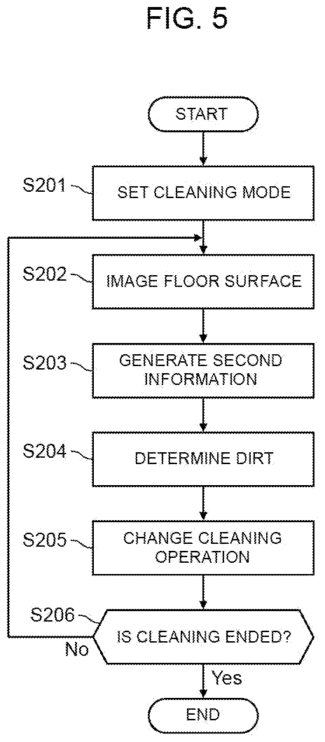

A flow of a cleaning operation performed by cleaner 130 will be described below. FIG. 5 is a flowchart of the cleaning operation performed by the cleaner. When a floor surface is cleaned by using cleaner 130 that autonomously travels, cleaner 130 is set to the registration mode (S201).

Cleaner 130 is caused to travel in accordance with a preset cleaning plan and clean the floor surface while imaging device 137 is imaging the floor surface on the front side in a traveling direction of cleaner 130 at predetermined intervals (S202). Second information generator 171 generates the second information based on the imaged image data (S203).

Determination unit 172 generates a determination result that is generated by comparing the first information with the second information or inputting the second information into the determination model and indicates whether the second information indicates dirt (S204). Note that when position information, information indicating the floor type, and the like are associated with the first information or determination model acquired by comparative information acquisition unit 177, determination unit 172 selects the first information or determination model associated with the information corresponding to the floor surface type classified by second floor type classifier 178, and generates a determination result.

Cleaning controller 173 changes the cleaning operation on the floor surface, on which the second information is acquired, in accordance with the determination result of determination unit 172 (S205). Note that the cleaning operation is not changed depending on the determination result. Cleaner 130 repeats the operations from the floor surface imaging (S202) to the change of the cleaning operation (S205) until the cleaning is completed (S206).

In cleaner system 100 according to the present exemplary embodiment, an actual state of a floor surface is determined from second information generated based on an image acquired by imaging device 137 included in cleaner 130, based on accumulated first information or a determination model trained by the first information, and the cleaning operation can be changed in accordance with a determination result. This can reduce erroneous detection of dirt due to a design of the floor or the like and appropriately clean the floor surface.

Further, dirt detection accuracy can be improved by changing data for determination in accordance with a floor type.

Further, recognition of an obstacle can improve the determination accuracy of dirt on a floor surface, and thus the cleaning operation can be changed to an appropriate operation including an avoiding operation in accordance with the type of the obstacle.

Note that the present disclosure is not limited to the above exemplary embodiment. For example, in the present disclosure, another exemplary embodiment may be achieved by combining any components described in the specification or excluding some of the components. Further, the present disclosure also includes modifications conceivable by those skilled in the art and obtained by variously modifying the above-described exemplary embodiment without departing from the spirit of the present disclosure, that is, the meaning indicated by the words described in the claims.

For example, the image data for generating the first information has been described as the image data regarding specific regions acquired by imaging the floor surface to be cleaned by cleaner 130, but the image data may be so-called big data acquired by imaging unspecified regions at a plurality of locations.

Further, a cleaning preparation mode may be executed before a shift to the cleaning mode. Specifically, second information at a plurality of locations may be generated by causing cleaner 130 to travel in accordance with the cleaning plan or along any route without performing the cleaning operation and to perform imaging more than once. Then, the cleaning plan in accordance with dirt on a floor surface may be updated or generated based on the second information and the first information.

Although cleaner 130 and information processing apparatus 110 have been described as separate components, cleaner 130 may include information processing apparatus 110.

Further, at least one of second information generator 171, second floor type classifier 178, and determination unit 172 described as being included in cleaner 130 may be achieved in information processing apparatus 110.

Further, at least one of data acquisition unit 111, first information generator 112, first floor type classifier 114, and model training unit 113 described as being included in information processing apparatus 110 may be achieved in cleaner 130.

Further, in the above description, the first information, the second information, and the determination model are classified for each floor type, and the determination is made for each floor type. However, dirt on a floor may be determined using the first information or one determination model trained by including the floor type as a parameter in the second information or by the first information including the floor type.

The present disclosure is usable in a cleaner system including an autonomous travel type cleaner.

What is claimed is:

1. A cleaner system comprising:
a cleaner that autonomously travels to clean a floor surface, the cleaner including an imaging device that images the floor surface;
an information processing apparatus that processes information about dirt on the floor surface, the information processing apparatus including a first information generator that generates first information about dirt based on a plurality pieces of image data indicating the floor surface;
a second information generator that generates second information based on image data acquired from the imaging device;
a determination unit that determines whether the second information indicates dirt, based on the first information and generates a determination result; and
a cleaning controller that changes a cleaning operation on the floor surface on which the second information is acquired, based on the determination result of the determination unit.

2. The cleaner system according to claim 1,
wherein the information processing apparatus includes a model training unit that trains a determination model based on a plurality of different pieces of the first information, and
wherein the determination unit determines whether the second information indicates dirt, using the determination model trained by the plurality of pieces of the first information, and generates a determination result.

3. The cleaner system according to claim 1, further comprising a notification unit that notifies about the determination result of the determination unit.

4. The cleaner system according to claim 1,
wherein the cleaner includes an obstacle detector that detects an obstacle, and
wherein the second information generator generates the second information from image data excluding the detected obstacle.

5. The cleaner system according to claim 1,
wherein the cleaner includes an obstacle detector that detects an obstacle and specifies a type of the obstacle, and
wherein the cleaning controller changes a cleaning operation in accordance with the type of the obstacle.

6. The cleaner system according to claim 1, further comprising:
a first floor type classifier that classifies a type of a floor surface,
wherein the information processing apparatus generates the first information for each type of floor surfaces, and
wherein the determination unit
generates the determination result based on the first information corresponding to the type of the floor surface.

7. A cleaner comprising:
an imaging device that images a floor surface;
an information acquisition unit that acquires first information about dirt based on a plurality of pieces of image data indicating the floor surface and a determination model trained by the first information;
a second information generator that generates second information based on image data acquired from the imaging device;
a determination unit that determines whether the second information indicates dirt, based on the first information or using the determination model trained by the first information, and generates a determination result; and
a cleaning controller that changes a cleaning operation on the floor surface on which the second information is acquired, based on the determination result of the determination unit.

8. A non-transitory computer-readable storage medium storing a dirt determination program used in a cleaner system including a cleaner that autonomously travels to clean a floor surface and an information processing apparatus that processes information about dirt on the floor surface, the dirt determination program being executed by a processor to achieve:
a first information generator that generates first information about dirt based on image data indicating the floor surface;
a second information generator that generates second information based on image data indicating the floor surface;
a determination unit that determines whether the second information indicates dirt, based on the first information and generates a determination result; and
a cleaning controller that changes a cleaning operation on the floor surface on which the second information is acquired, based on the determination result of the determination unit.
